(19) United States
(12) Patent Application Publication
(10) Pub. No.: US 2008/0110257 A1
(43) Pub. Date: May 15, 2008

(54) Apparatus for measuring the amount of fuel

(76) Inventors: Jongsang Noh, Ulsan (KR); Jungmin Lee, Busan (KR); Jonggeun Cha, Ulsan (KR)

Correspondence Address: DICKSTEIN SHAPIRO LLP, 1825 EYE STREET NW, Washington, DC, 20006-5403, US

(21) Appl. No.: 11/905,579

(22) Filed: Oct. 2, 2007

(30) Foreign Application Priority Data
Nov. 10, 2006 (KR) 10-2006-0110778

(51) Int. Cl. G01N 9/00

(52) U.S. Cl. 73/32 A

(57) ABSTRACT

The present invention provides an apparatus for measuring the amount of fuel that detects an interface between air and fuel without using a contact and a float in order to measuring the amount of fuel in a fuel tank. The apparatus for measuring the amount of fuel includes a step pole plate unit, an oscillator unit, a rectifier circuit, a comparator circuit, and a CPU. The step pole plate unit includes pairs of first and second plates and a plurality of steps for detecting dielectric constants of materials between the first and second plates. The oscillator unit generates frequencies corresponding to the dielectric constants detected by the plurality of steps. The rectifier circuit or an F-V circuit converts the frequencies output from the oscillator unit into DC voltages corresponding to the frequencies. The comparator circuit compares the DC voltages output from the rectifier circuit or the F-V circuit with a reference voltage, and outputs signals corresponding to results of the comparison between the DC voltages and the reference voltage. The CPU detects a position of an interface between air and fuel on the basis of the signals output from the comparator circuit, and outputs the amount of fuel corresponding to the position of the interface between air and fuel.

### CROSS-REFERENCE TO RELATED APPLICATIONS

The present application is based on, and claims priority from, Korean Application Serial Number 10-2006-0110778, filed on Nov. 10, 2006, the disclosure of which is hereby incorporated by reference herein in its entirety.

### FIELD OF THE INVENTION

The present invention relates to an apparatus for measuring the amount of fuel, and more particularly, to an apparatus for measuring the amount of fuel that detects an interface between air and fuel without using a contact and a float in order to measure the amount of fuel in a fuel tank.

### BACKGROUND OF THE INVENTION

A float resistor contact type fuel measuring apparatus which uses a contact and a float is used as an apparatus for measuring the amount of fuel at present.

A float resistor contact type fuel measuring apparatus according to the related art includes a float arm, a contact, resistors, and a ceramic substrate. A float, which moves to correspond to a fuel level, is formed at one end of the float arm. The contact is formed at the other end of the float arm. The resistors come in contact with the contact. The resistors are printed on the ceramic substrate. When the float of the float arm moves to correspond to the fuel level in the float resistor contact type fuel measuring apparatus according to the related art, the contact formed at the other end of the float arm comes in contact with one of the resistors printed on the ceramic substrate due to the movement of the float. The amount of fuel is measured by using the amount of current that corresponds to a resistance value of the resistor coming in contact with the contact. However, the float resistor contact type fuel measuring apparatus according to the related art has problems in that the durability of the contact is low, contact failure frequently occurs, the ceramic substrate is damaged, and it is difficult to accurately measure the amount of fuel.

Further, a capacitance type fuel measuring apparatus has also developed as an apparatus for measuring the amount of fuel with the exception of the float resistor contact type fuel measuring apparatus. The capacitance type fuel measuring apparatus includes a measurement pole plate, a compensation pole plate, and a negative plate, and uses characteristic where a capacitance is changed depending on the amount of a dielectric between the pole plates.

A capacitance type fuel measuring apparatus in the related art includes a measuring unit that is provided with a measurement pole plate and a negative plate, and a compensating unit that is provided with a compensation pole plate and a negative pole. The capacitance type apparatus measures the amount of fuel by using a frequency and amplitude, which correspond to a capacitance changing depending on the amount of fuel, that is, a dielectric between the measuring unit and the compensating unit. In the capacitance type fuel measuring apparatus in the related art, the negative plate of the measuring unit and the negative plate of the compensating unit are always submerged under fuel. Further, the measuring unit and the compensating unit always oscillate at a frequency having constant amplitude. However, the plates of the compensating unit are formed to be smaller than those of the measuring unit so that the frequency of the compensating unit is oscillated to be smaller than that of the measuring unit. Accordingly, the amount of fuel is measured by the comparison between the frequencies of the measuring unit and the compensating unit. When fuel having the same dielectric constant is only used, the capacitance type fuel measuring apparatus in the related art can accurately measure the amount of fuel. However, the fuel of a vehicle does not always use fuel having the same dielectric constant, and may use the mixture of fuel having different dielectric constants. Therefore, when the mixture of fuel having different dielectric constants is used, there is a problem in that the capacitance type fuel measuring apparatus in the related art has difficulty in accurately measuring the amount of fuel. Further, moisture is generated in a fuel tank storing fuel during the supply of fuel or at normal times. For this reason, the capacitance type fuel measuring apparatus in the related art has difficulty in accurately measuring the amount of fuel due to moisture that is generated during the supply of fuel or at normal times. Accordingly, the capacitance type fuel measuring apparatus in the related art cannot be used as an apparatus for measuring the amount of fuel, and has been used as a theoretical apparatus.

### SUMMARY OF THE INVENTION

Embodiments of the present invention provide an apparatus for measuring the amount of fuel that detects an interface between air and fuel without using a contact and a float in order to measure the amount of fuel in a fuel tank.

According to an embodiment of the present invention, an apparatus for measuring the amount of fuel includes a step pole plate unit, an oscillator unit, a rectifier circuit or an F-V circuit, a comparator circuit, and a CPU. The step pole plate unit includes pairs of first and second plates and a plurality of steps for detecting dielectric constants of materials between the first and second plates. The oscillator unit generates frequencies corresponding to the dielectric constants detected by the plurality of steps. The rectifier circuit or an F-V circuit converts the frequencies output from the oscillator unit into DC voltages corresponding to the frequencies. The comparator circuit compares the DC voltages output from the rectifier circuit or the F-V circuit with a reference voltage and outputs signals corresponding to results of the comparison between the DC voltages and the reference voltage. The CPU detects a position of an interface between air and fuel on the basis of the signals output from the comparator circuit. The CPU outputs the amount of fuel corresponding to the position of the interface between air and fuel.

The apparatus may further include a filter unit that removes noise from the frequencies output from the oscillator unit.

When the DC voltage corresponding to the frequency output from the rectifier circuit is equal to or larger than a reference voltage, the comparator circuit may output a positive signal. Further, when the DC voltage corresponding to the frequency output from the rectifier circuit is equal to or smaller than the reference voltage, the comparator circuit may output a negative signal.

When the DC voltage output from the rectifier circuit is equal to or larger than the reference voltage, the frequency input to the rectifier circuit may correspond to the dielectric constant of the fuel. Further, when the DC voltage output from the rectifier circuit is equal to or smaller than the reference voltage, the frequency input to the rectifier circuit may correspond to the dielectric constant of air.

The step pole plate unit may further include a first step pole plate unit that includes a pair of first and second plates, and at least one step pole plate unit that includes a pair of first and second plates different from the pair of first and second plates included in the first step pole plate unit.

The first and second plates of the step may be spaced from each other by a predetermined distance.

The first and second plates of at least one step pole plate unit and the first and second plates of the first step pole plate unit may be alternately disposed.

### BRIEF DESCRIPTION OF THE DRAWINGS

For a better understanding of the nature and objects of the present invention, reference should be made to the following detailed description with the accompanying drawings, in which:

FIG. 1 is a block diagram of an apparatus for measuring the amount of fuel according to an embodiment of the present invention;

FIG. 2 is a view showing an example of a step pole plate of the apparatus for measuring the amount of fuel according to the embodiment of the present invention; and

FIG. 3 is a view showing another example of the step pole plate of the apparatus for measuring the amount of fuel according to the embodiment of the present invention.

### DETAILED DESCRIPTION OF THE PREFERRED EMBODIMENTS

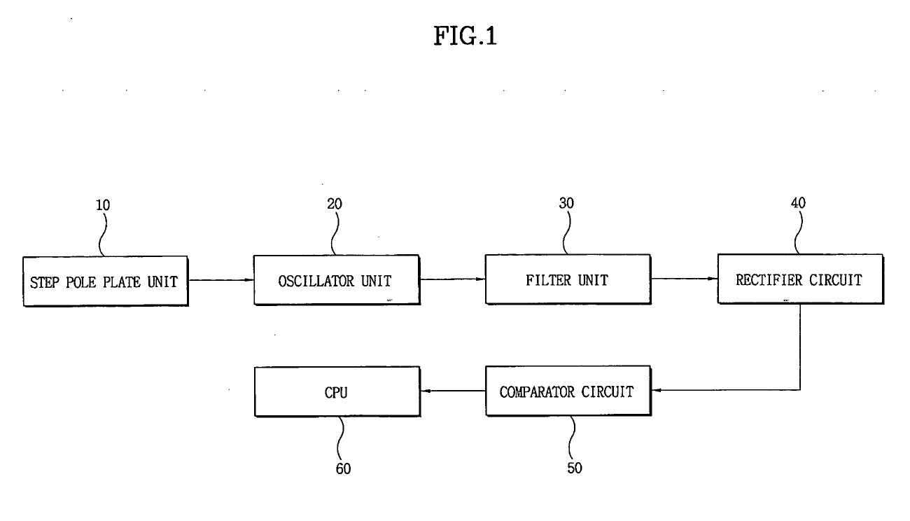

A preferred embodiment of the present invention will be described in detail below with reference to FIGS. 1 to 3.

FIG. 1 is a block diagram of an apparatus for measuring the amount of fuel according to an embodiment of the present invention.

Referring to FIG. 1, an apparatus for measuring the amount of fuel according to an embodiment of the present invention includes a step pole plate unit 10, an oscillator unit 20, a filter unit 30, a rectifier circuit 40 or an F-V circuit, a comparator circuit 50, and a CPU 60. Step pole plate unit 10 includes a plurality of steps for detecting dielectric constants of materials. Oscillator unit 20 generates frequencies corresponding to the dielectric constants. Filter unit 30 removes noise from the frequencies output from oscillator unit 20. Rectifier circuit 40 or the F-V circuit (not shown) converts the frequencies, which do not have noise and are output from filter unit 30, into DC voltages corresponding to the frequencies. Comparator circuit 50 compares the DC voltages output from rectifier circuit 40 or the F-V circuit with a predetermined reference voltage. CPU 60 detects a position of an interface between air and fuel on the basis of signals output from comparator circuit 50, and outputs the amount of fuel corresponding to the position of the interface between air and fuel.

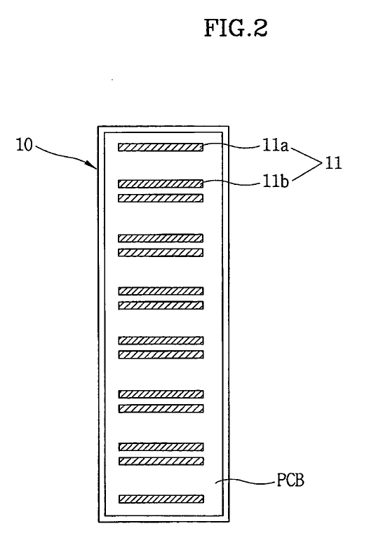

As shown in FIG. 2, step pole plate unit 10 includes a plurality of steps 11 formed on PCBs facing each other. Each of steps 11 includes a pair of first and second plates 11a and 11b. Each of steps 11 detects a dielectric constant of a material between first and second plates 11a and 11b.

Oscillator unit 20 generates and outputs a frequency corresponding to a dielectric constant of a material, which is provided between first and second plates 11a and 11b of each of steps 11.

Filter unit 30 removes noise from the frequencies, which are output from oscillator unit 20, and then output the frequencies.

Rectifier circuit 40 or the F-V circuit (not shown) converts the frequencies, which do not have noise and are output from filter unit 30, into DC voltages corresponding to the frequencies. Then, rectifier circuit 40 or the F-V circuit outputs the DC voltages.

When the DC voltage corresponding to the frequency, which is output from rectifier circuit 40 and corresponds to the dielectric constant of the material provided in each of steps 11, is equal to or larger than a reference voltage, comparator circuit 50 outputs a positive signal. Further, when the DC voltage corresponding to the frequency, which is output from rectifier circuit 40 and corresponds to the dielectric constant of the material provided in each of the steps, is equal to or smaller than the reference voltage, comparator circuit 50 outputs a negative signal. In this case, difference between dielectric constants of air and fuel is considerably large. Accordingly, when the DC voltage output from rectifier circuit 40 is equal to or larger than the reference voltage, the frequency input to rectifier circuit 40 corresponds to the dielectric constant of the fuel. When the DC voltage output from rectifier circuit 40 is equal to or smaller than the reference voltage, the frequency input to rectifier circuit 40 corresponds to the dielectric constant of air.

CPU 60 detects a step, in which the interface between air and fuel is presently positioned, among the steps of step pole plate unit 10, or two steps thereof between which the interface between air and fuel is presently positioned, on the basis of signals output from comparator circuit 50. Then, the CPU outputs the amount of fuel corresponding to the position of the interface between air and fuel.

Accordingly, the apparatus for measuring the amount of fuel according to the embodiment of the present invention detects the interface between air and fuel without using a contact and a float in order to measure the amount of fuel.

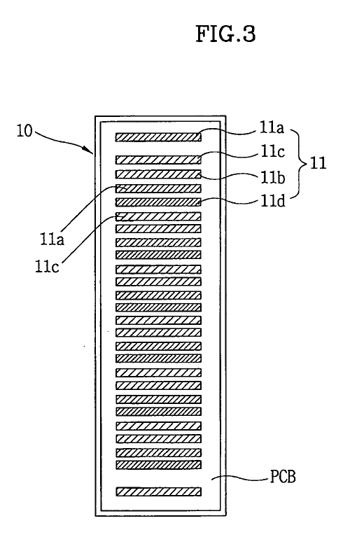

Further, in the apparatus for measuring the amount of fuel according to the embodiment of the present invention, first and second plates 11a and 11b of each step 11 of step pole plate unit 10 should be spaced from each other by a predetermined distance so as to detect a dielectric constant of a material. Accordingly, step pole plate unit 10 of the apparatus for measuring the amount of fuel according to the embodiment of the present invention includes a first step pole plate unit and a second step pole plate unit in order to more accurately measure the amount of fuel. First and second plates 11a and 11b of the first step pole plate unit, and first and second plates 11c and 11d of the second step pole plate unit are alternately disposed as shown in FIG. 3. That is, first plate 11c and second plate 11d of the second step pole plate unit are disposed between first and second plates 11a and 11b of the first step pole plate unit, and first plate 11a and second plate 11b of the first step pole plate unit are disposed between first and second plates 11c and 11d of the second step pole plate unit. Therefore, the apparatus for measuring the amount of fuel according to the embodiment of the present invention can more accurately measure the amount of fuel. In this case, the number of step pole plate unit 10 is not limited to two, which is the number of the first and second step pole plate units.

As described above, the apparatus for measuring the amount of fuel in a fuel tank according to the embodiment of the present invention detects a step, in which the interface between air and fuel is presently positioned, among steps 11 of step pole plate unit 10, or two steps thereof between which the interface between air and fuel is presently positioned, by using frequencies corresponding to the dielectric constants of the materials in the regions of step pole plate unit 10 in which the plurality of steps 11 is disposed, DC voltages corresponding to the frequencies, and output signals corresponding to the results of the comparison between the DC voltages and the reference voltage, thereby measuring the amount of fuel. Therefore, the apparatus for measuring the amount of fuel according to the embodiment of the present invention detects the interface between air and fuel without using a contact and a float in order to measure the amount of fuel.

As described above, the apparatus for measuring the amount of fuel in a fuel tank according to the embodiment of the present invention detects a step, in which the interface between air and fuel is presently positioned, among steps 11 of step pole plate unit 10, or two steps thereof between which the interface between air and fuel is presently positioned, thereby measuring the amount of fuel. Therefore, the apparatus for measuring the amount of fuel according to the embodiment of the present invention detects the interface between air and fuel without using a contact and a float in order to measure the amount of fuel.

What is claimed is:

1. An apparatus for measuring the amount of fuel, comprising:
a step pole plate unit that includes pairs of first and second plates and a plurality of steps for detecting dielectric constants of materials between the first and second plates;
an oscillator unit that generates frequencies corresponding to the dielectric constants detected by the plurality of steps;
a rectifier circuit or an F-V circuit that converts the frequencies output from the oscillator unit into DC voltages corresponding to the frequencies;
a comparator circuit that compares the DC voltages output from the rectifier circuit or the F-V circuit with a reference voltage and outputs signals corresponding to results of the comparison between the DC voltages and the reference voltage; and
a CPU that detects a position of an interface between air and fuel on the basis of the signals output from the comparator circuit, and outputs the amount of fuel corresponding to the position of the interface between air and fuel.

2. The apparatus as defined in claim 1, further comprising:
a filter unit that removes noise from the frequencies output from the oscillator unit.

3. The apparatus as defined in claim 1, wherein when the DC voltage corresponding to the frequency output from the rectifier circuit is equal to or larger than a reference voltage, the comparator circuit outputs a positive signal, and
when the DC voltage corresponding to the frequency output from the rectifier circuit is equal to or smaller than the reference voltage, the comparator circuit outputs a negative signal.

4. The apparatus as defined in claim 3, wherein when the DC voltage output from the rectifier circuit is equal to or larger than the reference voltage, the frequency input to the rectifier circuit corresponds to the dielectric constant of fuel, and
when the DC voltage output from the rectifier circuit is equal to or smaller than the reference voltage, the frequency input to the rectifier circuit corresponds to the dielectric constant of air.

5. The apparatus as defined in claim 1, wherein the step pole plate unit further includes:
a first step pole plate unit that includes a pair of first and second plates; and
at least one step pole plate unit that includes a pair of first and second plates different from the pair of first and second plates included in the first step pole plate unit.

6. The apparatus as defined in claim 5, wherein the first and second plates of the step are spaced from each other by a predetermined distance.

7. The apparatus as defined in claim 6, wherein the first and second plates of at least one step pole plate unit and the first and second plates of the first step pole plate unit are alternately disposed.
